(19) United States
(12) Patent Application Publication
(10) Pub. No.: US 2024/0403136 A1
(43) Pub. Date: Dec. 5, 2024

(54) CLOUD RESOURCES ALLOCATION OPTIMIZATION

(71) Applicant: Microsoft Technology Licensing, LLC, Redmond, WA (US)

(72) Inventors: Wenqin TANG, Suzhou, Jiangsu (CN); Gang WANG, Suzhou, Jiangsu (CN); Binhong ZHAO, Suzhou, Jiangsu (CN); ZhaoGuo JIANG, Suzhou, Jiangsu (CN)

(21) Appl. No.: 17/914,722

(22) PCT Filed: May 27, 2022
(86) PCT No.: PCT/CN2022/095487

§ 371 Date: Sep. 26, 2022

(51) Int. Cl. G06F 9/50

(52) U.S. Cl. CPC G06F 9/5083; G06F 9/5055; G06F 9/5077

(57) ABSTRACT

A computer system is configured to receive a request for allocation of a resource within a cloud environment that includes multiple regions. The computer system then identifies multiple subscriptions in each of the multiple regions. Each subscription is associated with a quota and a usage amount. For each region, the computer system computes a total quota indicating a sum of quotas of the multiple subscriptions and a total usage amount indicating a sum of used amount of the multiple subscriptions in the corresponding region, and computes a total usage ratio based on the total usage amount and the total quota. The computer system then selects a particular region in the multiple regions based on the total usage ratios, and selects a particular subscription in the multiple subscriptions in the particular region based on at least one rule that balances usage of different types of resources.

### BACKGROUND

Most cloud platforms support a plurality of regions, where each region has its own data centers, and each data center offers various resources to customers. Examples of resources include (but are not limited to) virtual central processing units (virtual processors), virtual networks (vNets), virtual machines (VMs), and disk encryption sets having a customer-managed key (CMK), disks, and the like.

Because resources are not infinite, resources need to be managed for efficient usage. Generally, each subscription has a set of quotas that can be allocated. In some cases, a cloud service books many subscriptions to support its production scale. A customer, located at a particular location, can request the resources from the cloud service. In response to receiving the request, the cloud service then allocates the requested resource to the customer.

Existing capacity managers often randomly select a region and/or a subscription to allocate resources for requests, which could result in inefficient usage of resources. In some cases, a resource in a subscription or a region may run out, and another resource in the subscription or the region could still be underused. For example, when a customer requests processors from a quota of 2000 virtual processors from the cloud service, even though a particular subscription in a particular region has a sufficient number of virtual processors (e.g., 2000 virtual processors), the result may be that only 1500 virtual processors can be allocated due to the limitations of other resources, such as (but not limited to) limitations associated with VMs, vNets, or CMKs and/or disks. In such a case, the 500 virtual processors in the subscription might never be able to be used due to the limitations of the other resources.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Principles described herein are related to a computer system for intelligent allocation of resources in a cloud environment. The computer system is configured to receive a request for allocation of a resource within a cloud environment that includes a plurality of regions, and identify a plurality of subscriptions in each of the plurality of regions. Each subscription is associated with a quota indicating a total amount of resource in the corresponding subscription and a usage amount indicating an amount of used resource in the corresponding subscription. For each region, the computer system further computes a total quota indicating a sum of quotas of the plurality of subscriptions and a total available amount indicating a sum of amounts of a plurality of subscriptions in the corresponding region. A total usage ratio for each region can then be computed based on the total usage amount and the total quota. The computer system is then configured to select a particular region in the plurality of regions, into which to allocate the resource based on the total usage ratios of the plurality of regions.

The computer system is further configured to select a particular subscription in the particular region based on usage of resources. Selecting the particular subscription includes determining a priority for each of the plurality of subscriptions located in the particular region based on at least one rule. The at least one rule is configured to balance usage of a particular type of resource. The computer system then selects the particular subscription in the plurality of subscriptions in the particular region based on the priorities of the plurality of subscriptions in the particular region, and allocates the resource that is requested for allocation from the particular subscription based on the request.

The principles described herein are also related to a method for intelligent allocation of resources in a cloud environment, which may be implemented at a capacity manager of a cloud service. The method includes receiving a request for allocation of a resource within a cloud environment that includes a plurality of regions, and identifying a plurality of subscriptions in each of the plurality of regions. Each subscription is associated with a quota indicating a total amount of resource in the corresponding subscription and a usage amount indicating an amount of used resource in the corresponding subscription. The method further includes, for each region, computing a total quota indicating a sum of quotas of the plurality of subscriptions and a total usage amount indicating a sum of usage amounts of the plurality of subscriptions in the corresponding region. For each region, the total usage ratio is then computed based on a ratio between the total usage amount and the total quota. A particular region in the plurality of regions is then selected based on the total usage ratios of the plurality of regions.

The method further includes selecting a particular subscription in the plurality of subscriptions in the particular region based on usage of resources in the plurality of subscriptions. Selecting the particular subscription includes determining a priority for each of the plurality of subscriptions in the particular region based on the at least one rule. The at least one rule is configured to balance usage of at least a particular type of resource. The method further includes selecting the particular subscription in the plurality of subscriptions in the particular region based on the priorities of the plurality of subscriptions in the particular region, and allocating the resource that is requested for allocation from the particular subscription based on the request.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates a cloud environment in which the principles described herein may be implemented;

FIG. 2 illustrates an example subscription having a set of quotas for different types of resources;

FIG. 3 illustrates an example process of selecting a particular region among a plurality of regions;

FIG. 4 illustrates an example subscription selector for selecting a particular subscription among a plurality of subscriptions in a particular region;

FIG. 5 illustrates an example process performed by a subscription filter for filtering a plurality of subscriptions in a particular region;

FIG. 6 illustrates a visualization presenting a plurality of subscriptions placed in a plurality of pools based on a usage ratio of virtual machines;

FIG. 7 illustrates a flowchart of an example method for intelligent selection of a particular subscription in a particular region;

FIG. 8 illustrates a flowchart of an example method for selecting a particular region among a plurality of regions;

FIG. 9 illustrates a flowchart of an example method for determining a set of rules having a higher priority;

FIG. 10 illustrates a flowchart of an example method for applying a set of rules associated with virtual processors;

FIG. 11 illustrates a flowchart of an example method for filtering a plurality of subscriptions based on their VM usage; and

FIG. 12 illustrates an example computer system in which the principles described herein may be employed.

### DETAILED DESCRIPTION

Most cloud platforms support a plurality of regions, each region has its own data centers, and each data center offers various physical resources. The various physical resources include (but are not limited to) virtual processors (e.g., virtual central processing units or vCPUs), virtual networks (vNets), virtual machines (VMs), disk encryption sets having a customer-managed key (CMK), and/or disks.

Because physical resources are not infinite, resources need to be managed for efficient usage thereof. Generally, each subscription has a set of quotas that can be allocated. In some cases, a cloud service books many subscriptions to support its production scale. A customer, located at a particular location, can request resources from the cloud service. In response to receiving the request, the cloud service then allocates the requested resource to the customer.

Existing capacity managers often randomly select a region and/or a subscription to allocate resources for requests, which could result in inefficient usage of resources. In some cases, a resource in a subscription or a region may run out, and another resource in the subscription or the region could still be underused. For example, when a customer requests virtual processors in a quota of 2000virtual processors from the cloud service, even though a particular subscription in a particular region has a sufficient number of virtual processors (e.g., 2000 virtual processors), the result may be that only 1500 virtual processors can be allocated due to the limitations of other resources, such as (but not limited to) limitations associated with VMs, vNets, CMKs and/or disks. In such a case, the 500 virtual processors in the subscription might never be able to be used due to the limitations of the other resources.

The present invention solves the above-described problem by automatically computing a priority of each resource for a desired allocation in response to receiving a request for allocation of resources. A particular subscription in a particular region is then selected to be used to allocate the requested resources based on the computed priorities.

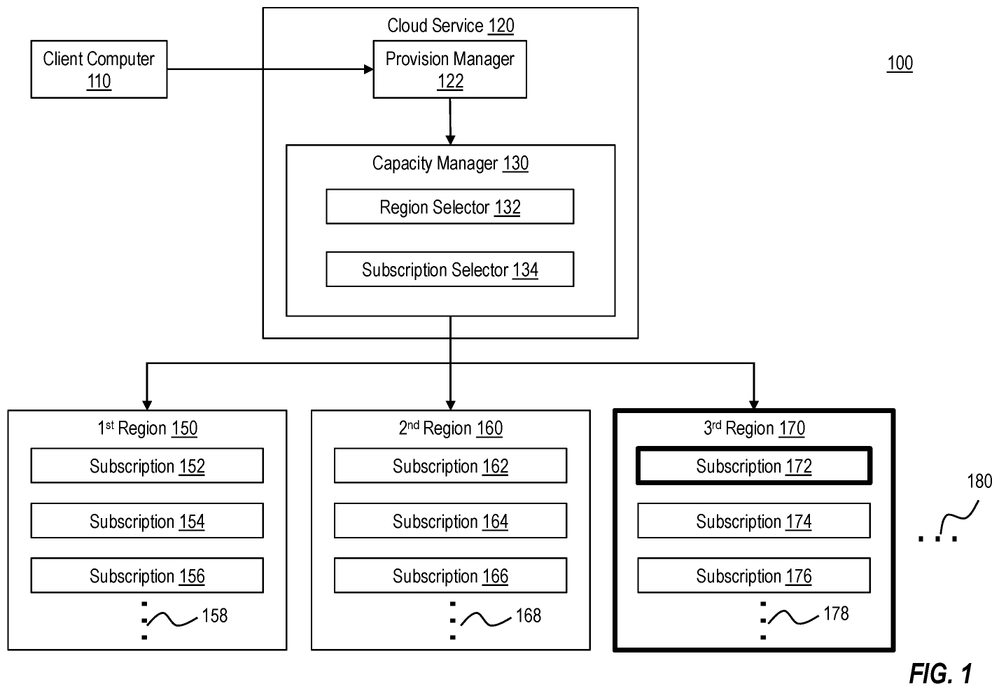

FIG. 1 illustrates an example cloud environment 100 in which the principles described herein may be implemented. The cloud environment 100 includes a client computer system 110 and a cloud service computer system 120. The cloud environment 100 further includes a plurality of regions, e.g., a first region 150, a second region 160, and a third region 170. The ellipsis 180 represents that there may be any number of regions in the cloud environment 100. Each of the plurality of regions includes a plurality of subscriptions. For example, the first region 150 includes subscriptions 152, 154, and 156. The ellipsis 158 represents that there may be any number of subscriptions in the first region 150. The second region 160 includes subscriptions 162, 164, 166, and the third region 170 includes subscriptions 172, 174, 176. The ellipsis 168 or 178 represents that there may be any number of subscriptions in the second region 160 or the third region 170.

The cloud service computer system 120 includes a provision manager 122 and a capacity manager 130. The provision manager 122 is configured to receive a request from the client computer system 110 for allocation of a resource within the cloud environment 100 and pass the request to the capacity manager 130. In some embodiments, the request indicates a request for allocation of a number of VMs from a customer. Based on the request, the provision manager 122 is configured to obtain a plan associated with the customer, identify a number of processors for each VM based on the plan associated with the customer, and pass the request including the number of VMs and the number of processors for each VM to the capacity manager 130.

In response to receiving the request for allocation of the resource, the capacity manager 130 is configured to identify a plurality of subscriptions in each of the plurality of regions (e.g., subsriptions 152, 154, 156, etc. in region 150; subscriptions 162, 164, 166, etc. in region 160; subscriptions 172, 174, or 176, etc in region 170; and so on). Each subscription is associated with a set of quotas indicating a total amount of different resources in the corresponding subscription and a usage amount indicating an amount of used resource in the corresponding subscription. In some embodiments, the set of quotas includes a first quota indicating a total amount of VMs, a second quota indicating a total amount of vNets, or a third quota indicating a total amount of disk encryption sets in a subscription.

For each region 150, 160, or 170, the capacity manager 130 is configured to compute a total quota indicating a sum of quotas of the plurality of subscriptions and a total usage amount indicating a sum of amounts of a plurality of subscriptions in the corresponding region 150,160, or 170, which can then be used to compute a total usage ratio and/or a total available ratio.

In some embodiments, the capacity manager 130 includes a region selector 132 and a subscription selector 134. The region selector 132 is configured to select a particular region in the plurality of regions (e.g., the third region 170) based on the total quota and the total usage amount of resources within each region in the plurality of regions 150, 160, or 170. The subscription selector 134 is further configured to select a particular subscription (e.g., subscription 172) in the particular region (e.g., the third region 170) for balancing usage of resources.

In some embodiments, selecting the particular subscription includes determining a priority for each of the plurality of subscriptions (e.g., subscriptions 172, 174, 176) located in the particular region (e.g., the third region 170) based on at least one rule. The at least one rule is configured to balance usage of at least a particular type of resource. The computer system then selects the particular subscription of the plurality of subscriptions within the particular region based on priorities of the plurality of subscriptions in the particular region, and allocates the resource that is requested for allocation from the particular subscription based on the request.

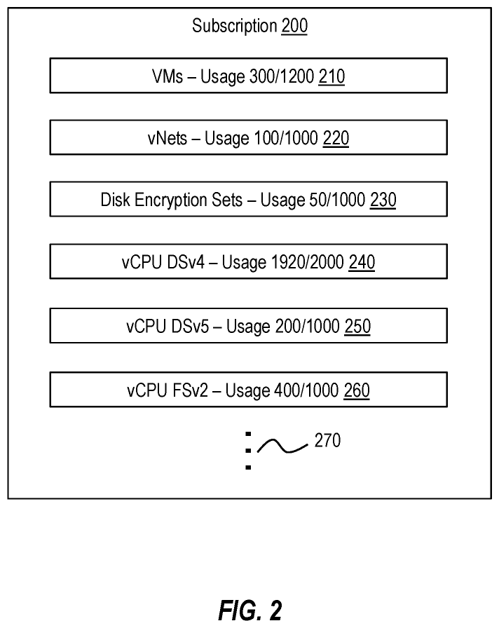

As briefly discussed above, in some embodiments, each subscription has a set of quotas for a plurality of types of resources, and the resource that is requested for allocation includes one or more types of the resources. FIG. 2 illustrates an example subscription 200, corresponding to each of subscriptions 152, 154, 156, 162, 164, 166, 172, 174, and/or 176 in FIG. 1. The subscription 200 includes a first quota 210 for VMs, a second quota 220 for vNets, and a third quota 230 for disk encryption sets. The subscription 200 also includes a set of quotas for virtual processors, including (but not limited to) a fourth quota 240 for virtual CPU (central processing unit) DSv4, a fifth quota 250 for virtual CPU DSv5, and/or a sixth quota 260 for virtual CPU FSv2. Ellipsis 270 represents that the subscription 200 may have any number of quotas for any number of types of resources.

As illustrated, in the subscription 200, the first quota 210 for VMs is 1200, and a usage of VMs is 300. As such, a number of available VMs in the subscription 200 is 900=1200−300, a usage ratio of VMs in the subscription 200 is 25%=300/1200, and a available ratio of VMs in the subscription 200 is 75%=900/1200. Similarly, the second quota 220 for vNets is 1000, and a usage of vNets is 100. As such, a number of available vNets in the subscription 200 is 900=1000−100, a usage ratio of vNets in the subscription 200 is 10%=100/1000, and a available ratio of vNets in the subscription 200 is 90%=900/1000.

Again, the third quota 230 for disk encryption sets is 1000, and a usage of disk encryption sets is 50; the fourth quota 240 for virtual CPU DSv4 is 2000, and a usage of virtual CPU DSv4 is 1920; the fifth quota 250 for virtual CPU DSv5 is 1000, and a usage of virtual CPU DSv5 is 200, and the sixth quota 260 for virtual CPU FSv2 is 1000, and a usage of virtual CPU FSv2 is 400. Based on the quotas and the usages of each type of resources, a usage ratio and/or a available ratio of each type of resources can also be computed.

Referring back to FIG. 1, each region includes a plurality of subscriptions. For each region, a total usage ratio for each type of resources can be computed based on the quotas and usages of resources in the plurality of subscriptions. In some embodiments, the region selector 132 is configured to select the particular region in the plurality of regions based on the total usage ratios of the different types of resources in each region.

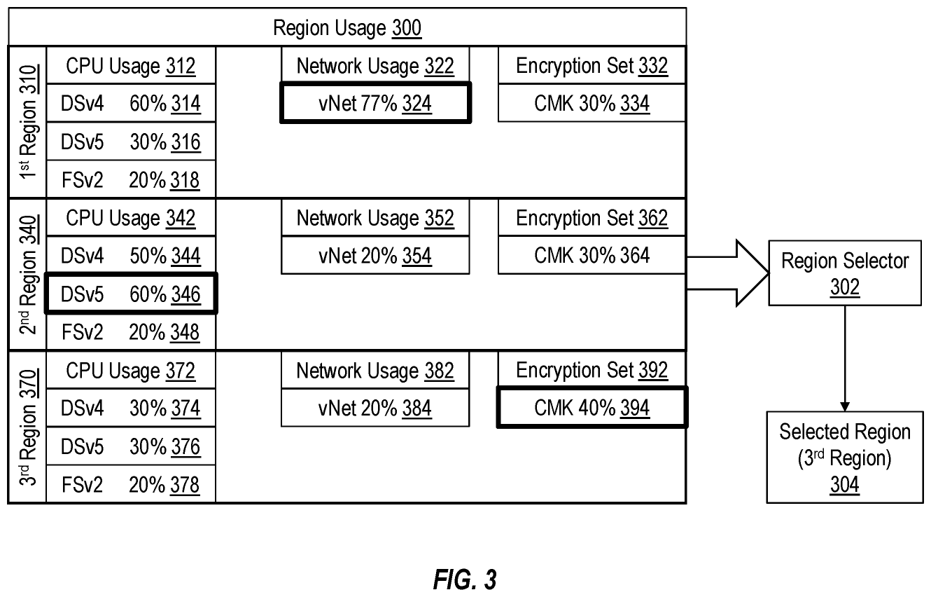

FIG. 3 illustrates an example process performed by a region selector 302 for selecting a particular region among the plurality of regions based on total usage ratios of the different types of resources in each region. As illustrated in FIG. 3, for each region (e.g., a first region 310, a second region 340, and a third region 370), a set of usage ratios are computed for different types of resources, such as (but not limited to) CPU usage 312, 342, 372, network usage 322, 352, 382, and/or disk encryption set usage 332, 362, 392. In some embodiments, the CPU usage 312, 342, 372 further includes a plurality of subset of usage ratios 314, 316, 318, 344, 346, 348, 374, 376, 378, corresponding to different types of processors, such as (but not limited to) DSv4, DSv5, and/or FSv2. The network usage 322, 352, 382 includes a vNet usage ratio 324, 354, 384, and the disk encryption set 332, 362, 392 includes a CMK usage ratio 334, 364, 394.

For each region of the first region 310, second region 340, and third region 370, a highest usage ratio among the multiple usage ratios for different types of resources is identified. For example, in the first region 310, the highest usage ratio is the vNet usage ratio 324 (=77%) among the ratios 314, 316, 318, 324, and 334; in the second region 340, the highest usage ratio is the DSv5 usage ratio 346 (=60%) among the ratios 344, 346, 348, 354, and 346; and in the third region 370, the highest usage ratio is the CMK usage ratio 394 (=40%) among the ratios 374, 376, 378, 384, and 394.

These highest usage ratios 324 (=77%), 346 (=60%), and 394 (=40%) are then sorted based on usage ratio (e.g., in an ascending order, lowest usage ratio to highest usage ratio). Based on this sorting, the the lowest usage ratio is identified, and a corresponding region is then selected as the particular region. For example, here, the disk encryption set 394 (40%) of the third region 370 is the lowest among the highest usage ratios 324, 346, 394 (i.e., vNet usage ratio 324=77%, DSv5 usage ratio 346=60%, CMK usage ratio 394=40%). As such, the region selector 302 selects the third region 370 as the particular region 304.

In some embodiments, the cloud service is configured to regularly scan usage and automatically calculate different resource capacities used and/or left for each region and automatically prioritize the different sets of rules based on the different resource capacities.

As briefly discussed above with respect to FIG. 1, when the particular region is selected, the subscription selector 134 is then configured to select a particular subscription from the particular region. In some embodiments, a relationship among different resources is used to identify the set of rules. In some embodiments, the set of rules may be set based on a total capacity of ratio between two types of different resources. A total capacity ratio is a ratio between a first total number of a first type of available resource and a second total number of a second type of available resource.

Because some requests for resources rely on VMs, in some embodiments, the set of rules may be set based on a ratio between a number of a type of available resource (that is not VM) to a number of available VMs. For example, a total capacity ratio may be a ratio between a number of available virtual processors and a number of available VMs. When a total number of available VMs is 1200, a total number of available virtual processors is 2000, a total number of available vNets is 1000, a total number of disk encryption sets is 50000, and a total number of disk encryption sets is 1000, the total capacity ratio between virtual processors and VMs would be 2000:1200=1:0.6, between vNets and VMs would be 1000:1200=1:1.2, between disk encryption sets and VMs would be 50000:1200=50:1.2, and/or between disk encryption sets and VMs would be 1000:1200=1:1.2.

In some embodiments, for each type of resource (that is other than VMs), there is a separate set of rules for balancing that type of resource relative to VMs. For example, a first set of virtual processor rules is configured to balance allocation of virtual processors relative to VMs, a second set of vNet rules is configured to balance allocation of vNets relative to VMs, a third set of CMK rules is configured to balance allocation of CMKs relative to VMs, and/or a fourth set of disk rules is configured to balance allocation of disks relative to VMs. In some embodiments, the request for resources includes a service plan, indicating a number of VMs and a number of virtual processors for each VM. This information can be used to set priorities for subscriptions to prioritize usage of virtual processors.

In some embodiments, when a request for a first number of VMs is received, a provision manager 122 is configured to combine several other resources with the VMs together and send the first number of VMs and the combined other resources to a capacity manager 130. For example, the several other resources that are to be combined with the first number of the VMs may include a second number of virtual processors, a third number of VNets, a fourth number of CMK and/or a fifth number of disks, which are to be provisioned for the VM. The provision manager 122 then sends a request for the first number of VMS, the second number of virtual processors, the third number of VNet, the fourth number of CMK, and/or the fifth number of disks to a capacity manager 130, which in turn books these resources accordingly. The capacity manager 130 is configured to check each supported region and subscription therein to find a desired region and subscription for allocating resources based on the request.

The capacity manager 130 applies at least one of the first set of virtual processor rules that is configured to balance allocation of virtual processors relative to VMs, the second set of vNet rules that is configured to balance allocation of vNets relative to VMs, the third set of CMK rules that is configured to balance allocation of CMKs relative to VMs, and/or the fourth set of disk rules that is configured to balance allocation of disks relative to VMs. Further details about the different sets of rules and how the different sets of rules are applied are discussed below.

For example, the first set of virtual processor rules includes multiple different rules based on the number of processors per VM indicated in the request. In some embodiments, when the number of virtual processors for each VM is one, the subscriptions are divided into two buckets based on the total capacity ratios between virtual processors and VMs. For example, in some embodiments, the subscriptions that have a total capacity ratio that is no greater than 1 is placed in a “less-than-one bucket”, and the subscriptions that have a total capacity ratio that is greater than 1 is placed in a “more-than-one bucket.” The subscriptions in the less-than-one bucket have higher priorities than the subscriptions in the more-than-one bucket. The subscriptions in the more-than-one bucket can then be ordered based on the total capacity ratios (e.g., in an ascending order).

For example, a selected region has three subscriptions, namely subscription A, subscription B, and subscription C. Subscription A has 1000 available virtual processors and 200 available VMs, subscription B has 1000 available virtual processors and 300 available VMs, and subscription C has 800 available virtual processors and 1000 available VMs. Subscription A corresponds to a total capacity ratio of 1000:200=5:1, subscription B corresponds to a total capacity ratio of 1000:300=3.3:1, and subscription C corresponds to a total capacity ratio 800:1000=0.8:1. Subscription A and subscription B would be placed in the more-than-one bucket, and subscription C would be placed in the less-than-one bucket. Thus, subscription C has a higher priority than subscription A and subscription B, and subscription B has a higher priority than subscription A.

In some embodiments, when the number of virtual processors for each VM is N, where 1<N<16, an absolute value of a total capacity ratio between virtual processors and VMs minus N is computed for each subscription, which can be represented by the following equation:

$$ABS ( capacity\_ratio - N ) ,$$

$$where capacity\_ratio = ( a number of available virtual processors ) / ( a number of available VMs ) ,$$

and N is a number of virtual processors for each requested VM.

The absolute values can then be ordered based on their priorities (e.g., in descending order, highest to lowest). The subscription with the highest priority is selected for allocating resources based on the request.

For example, when the number of virtual processors for each VM is two, an absolute value of a total capacity ratio between virtual processors and VMs minus two is computed for each subscription, which can be represented by the following equation:

$$ABS ( capacity\_ratio - 2 ) ,$$

$$where capacity\_ratio = ( a number of available virtual processors ) / ( a number of available VMs ) .$$

The absolute values can then be ordered based on their priorities (e.g., in descending order, highest to lowest). The subscription with the highest priority is selected for allocating resources based on the request. For example, a selected region has two subscriptions, namely subscription A and subscription B. Subscription A has 1000 available virtual processors and 200 available VMs, and subscription has 1000 available virtual processors and 300 available VMs. Subscription A corresponds to a total capacity ratio of 1000:200=5:1=5, and ABS (5−2)=3. Subscription B corresponds to a total capacity ratio of 1000:300=3.3:1=3.3, and ABS (3.3−2)=1.3. As such, subscription B would have a higher priority than subscription A.

As another example, when the number of virtual processors for each VM is eight, an absolute value of a total capacity ratio between virtual processors and VMs minus eight is computed for each subscription, which can be represented by the following equation:

$$ABS ( capacity\_ratio - 8 ) ,$$

$$where capacity\_ratio = ( a number of available virtual processors ) / ( a number of available VMs ) .$$

The absolute values can then be ordered based on their priorities (e.g., in descending order, highest to lowest). The subscription with the highest priority is selected for allocating resources based on the request. For example, a selected region has two subscriptions, namely subscription A and subscription B. Subscription A has 2000 available virtual processors and 200 available VMs, and subscription B has 2000 available virtual processors and 400 available VMs. Subscription A corresponds to a total capacity ratio of 2000:200=10:1, and ABS (10−8)=2. Subscription B corresponds to a total capacity ratio of 2000:400=5:1, and ABS (5−8)=ABS (−3)=3. As such, subscription A would have a higher priority than subscription B.

Assuming the request for resources requested 100 VMs (8 virtual processors) each, since subscription A has a higher priority than subscription B, these requested resources would be allocated from subscription A, which would result in that subscription A has 1200 (=2000−800) virtual processors and 100 (=200−100) VMs. Subscription B remains unchanged.

When a second request for resources is received, the capacity manager will recompute the priorities of each subscription based on their current status. Assuming the new request also indicates that the number of virtual processors for each VM is eight, subscription A now corresponds to a total capacity ratio of 1200:100=12:1, and ABS (12−8)=4, while subscription B still corresponds to a total capacity ratio of 2000:400=5:1, and ABS (5−8)=3. As such, subscription B now has a higher priority than subscription A, and subscription B will be used to allocate resources based on the second request.

In some embodiments, when the number of virtual processors for each VM is greater than eight, a different rule is used to set the priorities of the subscriptions. For example, in some embodiments, when the number of virtual processors for each VM is 16, a total capacity ratio between virtual processors and VMs is ordered based on their priorities (e.g., in descending order).

For example, when a selected region has four subscriptions, namely subscription A, subscription B, subscription C, and subscription D. Subscription A has 1000 available virtual processors and 200 available VMs, subscription B has 1000 available virtual processors and 300 available VMs, subscription C has 1800 available virtual processors and 200 available VMs, and subscription D has 2000 available virtual processors and 200 available VMs. Subscription A corresponds to a total capacity ratio of 1000:200=5:1, subscription B corresponds to a total capacity ratio of 1000:300=3.3:1, subscription C corresponds to a total capacity ratio of 1800:200=9:1, and subscription D corresponds to a total capacity ratio of 2000:200=10:1. A descending order of the total capacity ratios would result in subscription D (10), subscription C (9), subscription A (5), and subscription B (3.3). As such, subscription D has the highest priority and will be selected for allocating resources based on the request.

In some embodiments, a set of vNet rules is configured to balance the allocation of vNets relative to VMs. In some embodiments, the request is generally not allowed to request more than one vNet each time. Thus, the request for vNet is either 0 or 1.

In some embodiments, when a number of requested vNet is 0, the priorities of different subscriptions are set based on a total capacity ratio between available vNets and available VMs. For example, when a selected region includes two subscriptions, namely subscription A and subscription B. Subscription A includes 800 available VMs and 300 available vNets, and subscription B includes 800 available VMs and 100 available vNets. Subscription A corresponds to a total capacity ratio of 300/800=0.375, and subscription B corresponds to a total capacity ratio of 100/800=0.125. As such, subscription B has a higher priority than subscription A, and subscription B will be selected for allocating resources based on the request.

In some embodiments, when a number of requested vNet is 1, and a number of requested VM is also 1, the priorities of different subscriptions are set based on a total capacity ratio between available vNets and available VMs. For a same selected region as discussed above for the case of a number of requested vNet being 0, subscription A will be selected for allocating resources based on the request.

In some embodiments, when a number of requested vNet is 1, and a number of requested VM is greater than 1, the priorities of different subscriptions are set based on a total capacity ratio between available vNets and available VMs. For a same selected region as discussed above for the case of a number of requested vNet being 0, subscription B will also be selected for allocating resources based on the request.

In some embodiments, when a ratio between requested vNet and requested VMs equal to a ratio between available vNets and available VMs in a subscription and less than 1:1.2, consuming VM has a higher priority than consuming vNets.

In some embodiments, a disk encryption set includes a customer-managed key (CMK). A set of CMK rules is configured to balance the allocation of CMK relative to VMs. In some embodiments, the CMK rules are similar to the vNets rules, because, normally, a cloud service would also limit a number of CMK in each request to be no more than 1. As such, a number of CMK in a request is either 0 or 1.

Also similar to the vNet rules, in some embodiments, when a ratio between requested disk encryption set and requested VMs equal to a ratio between available CMK and available VMs in a subscription and less than 1:1.2, consuming VM has a higher priority than consuming disk encryption set.

In some embodiments, a set of disk rules is configured to balance the allocation of a disk set relative to VMs. In some embodiments, since a maximum limit on disk set and snapshot is more than 50000 per subscription and per region, while the limit of VMs is often around 1200, the capacity manager can simply order the subscriptions by a total capacity ratio between available disks and available VM.

In some embodiments, the set of virtual processor rules, the set of vNet rules, the set of CMK rules, and the set of disk rules also have their own priorities. These priorities may be set manually by users or automatically by the subscription selector 134. In some embodiments, users can manually set a priority for each set of rules. For example, if a user believes that using vNet is more important than using other resources, the set of vNet rules can be manually set to have a higher priority.

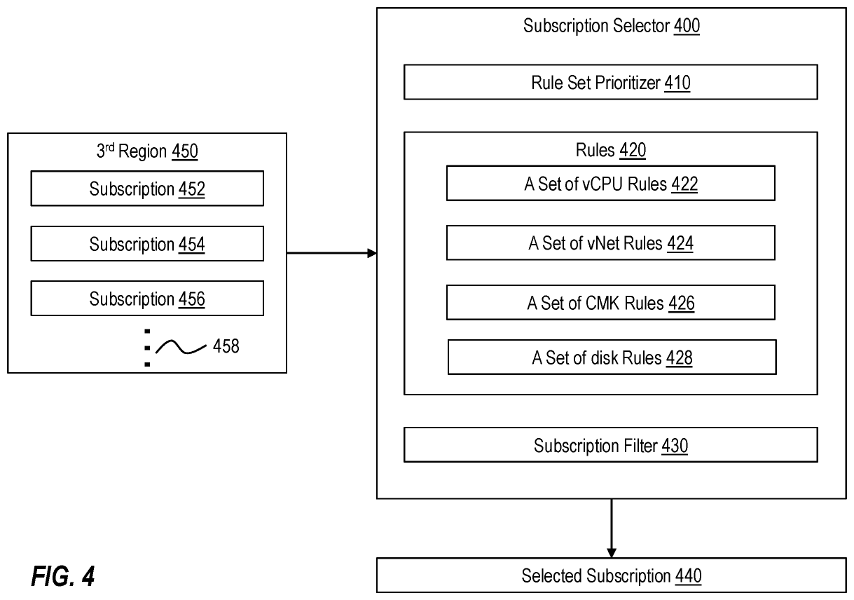

FIG. 4 illustrates an example subscription selector 400 corresponding to the subscription selector 134 of FIG. 1 configured to automatically select a subscription among a plurality of subscriptions in a particular region (e.g., a third region 450). As illustrated in FIG. 4, the third region 450 (corresponding to the third region 370) is selected as the particular region. The third region 450 includes a plurality of subscriptions 452, 454, 456. The ellipsis 458 represents that there may be any number of subscriptions in the third region 450. A subscription selector 400 (corresponding to the subscription selector 134) includes a rule set prioritizer 410 configured to set priorities of one or more sets of rules 420. The one or more sets of rules 420 include a first set of virtual processor (or vCPU) rules 422 configured to balance usage of virtual processors, a second set of vNet rules 424 configured to balance usage of vNets, a third set of CMK rules 426 configured to balance usage of CMKs, and/or a fourth set of disk rules 428 configured to balance usage of disks. Note, there may be any number of sets of rules configured to balance any types of resources.

In some embodiments, the rule set prioritizer 410 is configured to determine that a particular set of rules in the one or more sets of rules has a higher priority based on a usage ratio of each type of resource in the particular region. Referring back to FIG. 3, for example, in the third region 370, the DSv4 usage ratio 374 is 30%, the DSv5 usage ratio 376 is 30%, the FSv2 usage ratio 378 is 20%, the vNet usage ratio 384 is 20%, and the CMK usage ratio 394 is 40%. In some embodiments, the rule set prioritizer 410 identifies a highest usage ratio among the usage ratios 374, 376, 378, 384, 394 for the different types of resources in the third region 370 or 450. The set of rules corresponding to a type of resource that has the highest usage ratio is set to have the higher priority. Here, the highest usage ratio is the CMK usage ratio 394. Thus, the set of disk rules 428 is set to have higher priority than the set of virtual processor rules 422, the second set of vNet rules 424, and/or the third set of CMK rules 426.

In some embodiments, a set of rules having the higher priority will be able to overwrite the result of other set of rules. For example, in some embodiments, each set of rules 422, 424, 426, 428 is used to generate a priority order of the plurality of subscriptions 452, 454, 456 in the third region 450. When the multiple priority orders are in conflict, the priority order set by the disk rules 426 would overwrite the other priority orders.

In some embodiments, the set of rules having the higher priority is used to generate a priority order of the plurality of subscriptions 452, 454, 456 in the third region 450. When more than one subscription shares a same priority, another set of rules is used to further prioritize the more than one subscription.

In some embodiments, the subscription selector 400 further includes a subscription filter 430 configured to divide the plurality of subscriptions 452, 454, 456 in the third region 450 into a plurality of pools based on certain conditions, such as (but not limited to) VMs' usage percentage. The subscription selector 400 is configured to apply the one or more sets of rules based on filtering and/or priorities to select a particular subscription 440 among the plurality of subscriptions 452, 454, 456 in the third region 450.

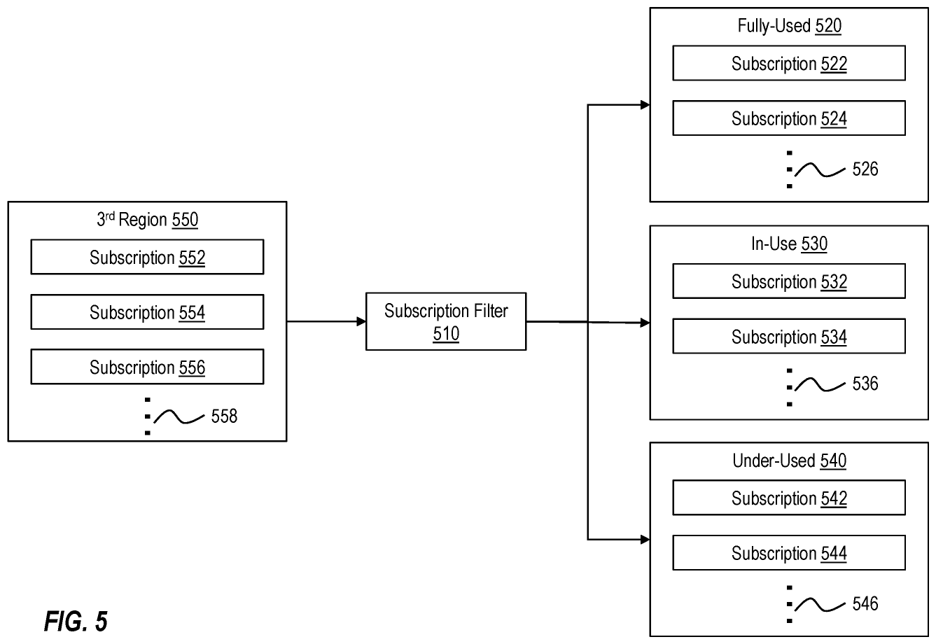

FIG. 5 illustrates an example process performed by a subscription filter 510 (corresponding to the subscription filter 430 of FIG. 4) for filtering the plurality of subscriptions in a particular region (e.g., a third region 550, corresponding to the third region 450). The third region 550 includes a plurality of subscriptions 552, 554, 556. Ellipsis 558 represents that there may be any number of subscriptions in the third region. In some embodiments, the subscriptions 552, 554, 556 that have a VMs' usage percentage lower than a first threshold (e.g., 30%) are placed into an under-used pool 540, the subscriptions that have a VMs' usage percentage higher than a second threshold (e.g., 70%) are placed into an almost full-used pool 520, and the subscriptions that have a VMs' usage percentage between the first threshold and the second threshold are placed into an in-use pool 530, where the first threshold<the second threshold.

Each of the full-used pool 520, the in-use pool 530, and/or the under-used pool 540 includes one or more subscriptions. As illustrated, the fully-used pool 520 includes subscriptions 522, 524; the in-use pool 530 includes subscriptions 532, 534; and the under-used pool 540 includes subscriptions 542, 544. The ellipsis 526, 536, 546 represent that there may be any number of subscriptions in the fully-used pool 520, the in-use pool 530, and/or the under-used pool 540.

In some embodiments, the subscription filter 510 is configured to identify a top predetermined number (e.g., top five, top ten, etc.) of subscriptions in the in-use pool 530. A particular subscription is then selected from the top predetermined number of subscriptions. In some embodiments, the particular subscription is randomly selected from the top predetermined number of subscriptions to avoid a race situation. In a race situation, multiple requests are received in a short period or nearly simultaneously. Without the random selection process, a particular subscription may be selected to allocate resources for all these requests, which may cause the particular subscription to overflow. In some embodiments, each usage ratio of virtual machines is computed based on assuming a number of virtual machines that are requested to be allocated have already been allocated into each of the plurality of subscriptions.

Note, the subscription filter 430, 510 may be placed before or after the rule set prioritizer 410. For example, in some embodiments, dividing and filtering the plurality of subscriptions may be performed first, and a priority for each of the subscriptions in the in-use pool is then identified. In some embodiments, a priority for each of the subscriptions in the region is identified first, and the plurality of subscriptions are then divided and filtered. In some embodiments, the priority for each subscription is computed periodically regardless of whether a request for allocation of resources is received. In some embodiments, the priority for each subscription is computed in response to receiving a request for allocation of resources.

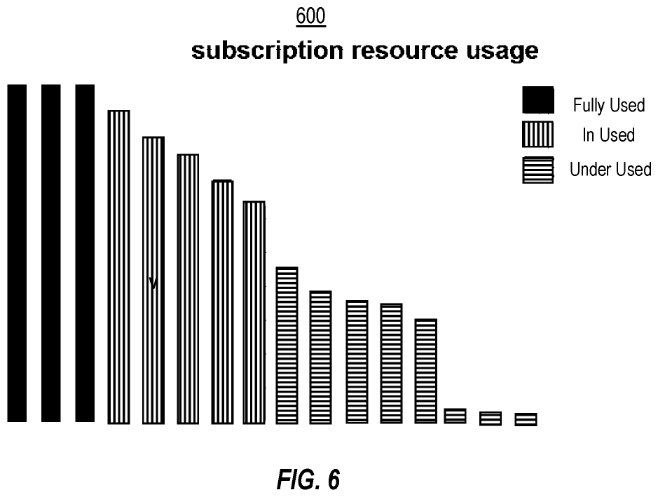

In some embodiments, the different pools of subscriptions are visualized in a user interface. FIG. 6 illustrates an example user interface 600 presenting a plurality of subscriptions in a particular region divided into a fully-used pool, an in-use pool, and an under-used pool.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

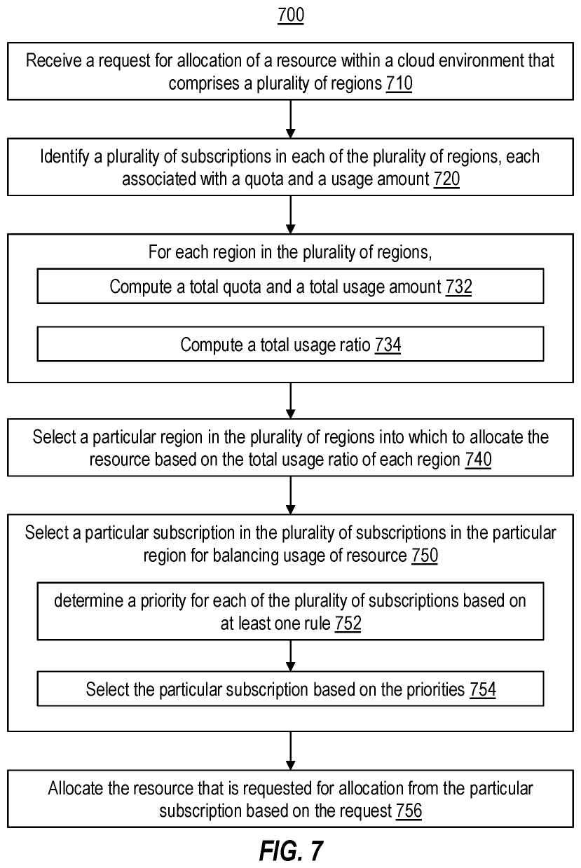

FIG. 7 illustrates a flowchart of an example method for intelligent allocation of resources in a plurality of regions, each of which includes a plurality of subscriptions. The method 700 includes receiving a request for allocation of a resource within a cloud environment that comprises a plurality of regions (act 710). The method 700 further includes identifying a plurality of subscriptions in each of the plurality of regions (act 720). Each subscription is associated with a quota indicating a total amount of resource in the subscription and a usage amount indicating an amount of resource that has been used in the subscription. For each region among the plurality of regions, a total quota and a total usage amount of resources are computed (act 732), and a total usage ratio indicating a ratio between the total usage amount and the total quota is also computed (act 734). A particular region in the plurality of regions is then selected for allocation of the resource based on the total usage ratio of each region (act 740).

The method 700 further includes selecting a particular subscription in the plurality of subscriptions in the particular region for balancing usage of resource (act 750). Selecting the particular subscription (act 750) includes determining a priority for each of the plurality of subscriptions (act 752) based on at least one rule, and selecting the particular subscription based on the priorities (act 754). The resource that is requested for allocation is then allocated from the particular subscription based on the request (act 756).

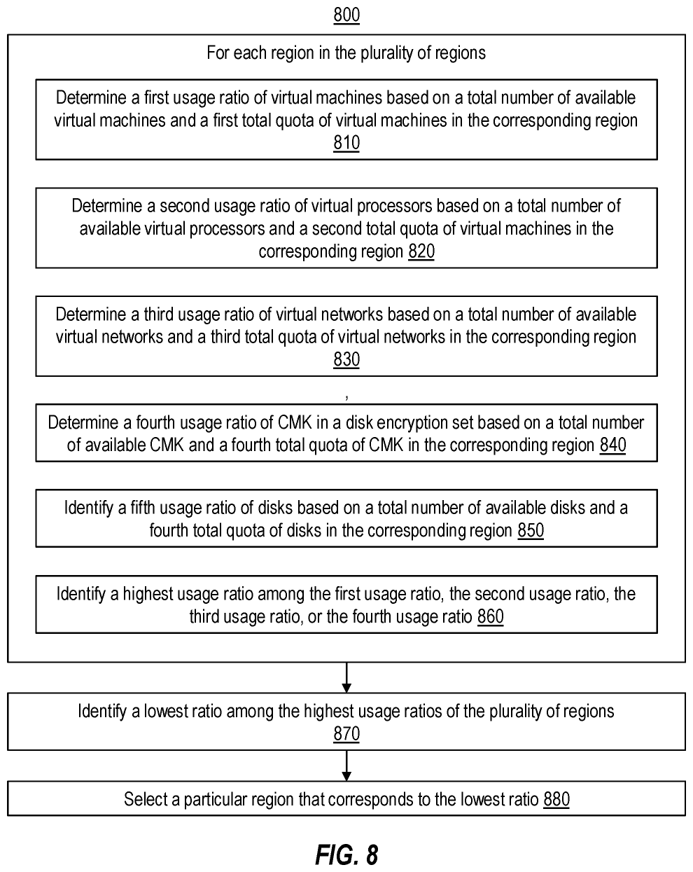

FIG. 8 illustrates a flowchart of an example method 800 for selecting a particular region among a plurality of regions (which corresponds to act 740 of FIG. 7). The method 800 includes, for each region in the plurality of regions, (1) determining a first usage ratio of virtual machines based on a total number of available virtual machines and a first total quota of virtual machines in the corresponding region (act 810); determining a second usage ratio of virtual processors based on a total number of available virtual processors and a second total quota of virtual machines in the corresponding region (act 820); determining a third usage ratio of virtual networks based on a total number of available virtual networks and a third quota of virtual networks in the corresponding region (act 830); determining a fourth usage ratio of CMK based on a total number of available CMK and a fourth total quota of CMK in the corresponding region (act 840), and/or determining a fifth usage ratio of disks based on a total number of available disks and a fifth total quota of disks in the corresponding region (act 850). Further, for each region in the plurality of regions, a highest usage ratio among the first usage ratio, the second usage ratio, the third usage ratio, the fourth usage ratio, and/or the fifth usage ratio is identified (act 860). The method 800 further includes identifying a lowest ratio among the highest usage ratios of the plurality of regions in (act 870) and selecting a particular region that corresponds to the lowest ratio (act 880).

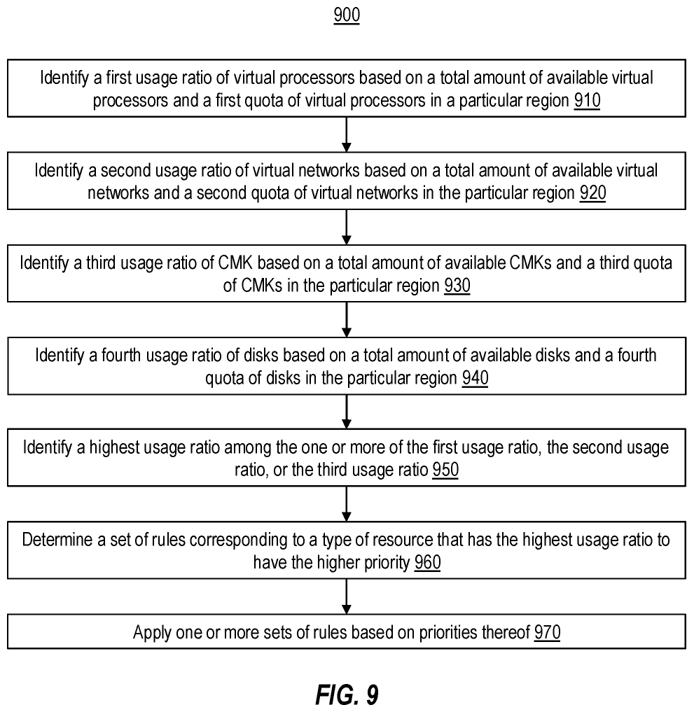

FIG. 9 illustrates a flowchart of an example method 900 for determining a priority for each of the plurality of subscriptions (corresponding to act 752 of FIG. 7) based on at least one rule. The method 900 includes identifying a first usage ratio of virtual networks based on a total amount of available virtual processors and a first quota of virtual processors in a particular region (act 910), identifying a second usage ratio of virtual networks based on a total amount of available virtual networks and a second quota of virtual networks in the particular region (act 920), identifying a third usage ratio of CMKs in disk encryption sets based on a total amount of available CMKs and a third quota of CMKs in the particular region (act 930), and/or identifying a fourth usage ratio of disks in disk encryption sets based on a total amount of available disks and a fourth quota of disks in the particular region (act 940). The method further includes identifying a highest usage ratio among the one or more of the first usage ratio, the second usage ratio, the third usage ratio, and/or the fourth usage ratio (act 950), determining a set of rules corresponding to a type of resources that has the highest usage ratio to have the higher priority (act 960), and applying one or more sets of rules based on the determined priorities thereof (act 970).

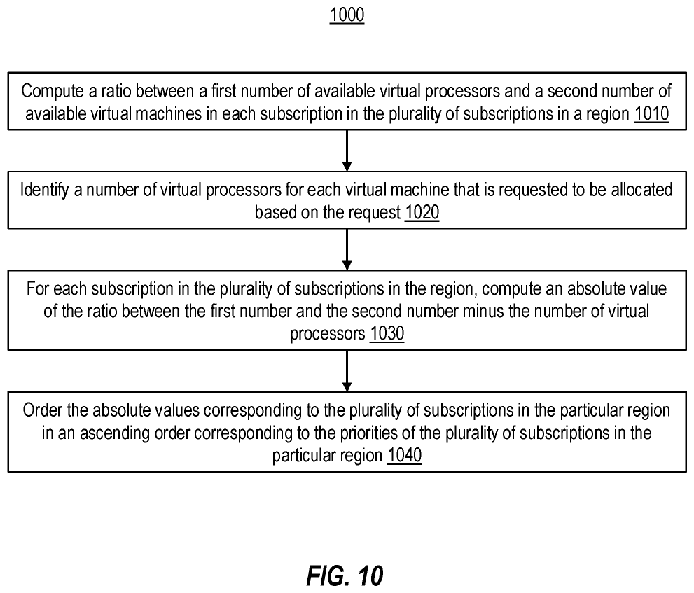

FIG. 10 illustrates a flowchart of an example method 1000 for applying a set of rules associated with virtual processors, which is one of the one or more sets of rules applied in act 752 of FIG. 7. The method 1000 includes computing a ratio between a first number of available virtual processors and a second number of available virtual machines in each subscription in the plurality of subscriptions in a region (act 1010); and identifying a number of virtual processors for each virtual machine that is requested to be allocated based on the request (act 1020). Further, for each subscription in the plurality of subscriptions in the region, an absolute value of the ratio between the first number and the second number minus the number of the virtual processors (act 1030). The absolute values can then be ordered (e.g., in an ascending order) corresponding to the plurality of subscriptions in the particular region (act 1040).

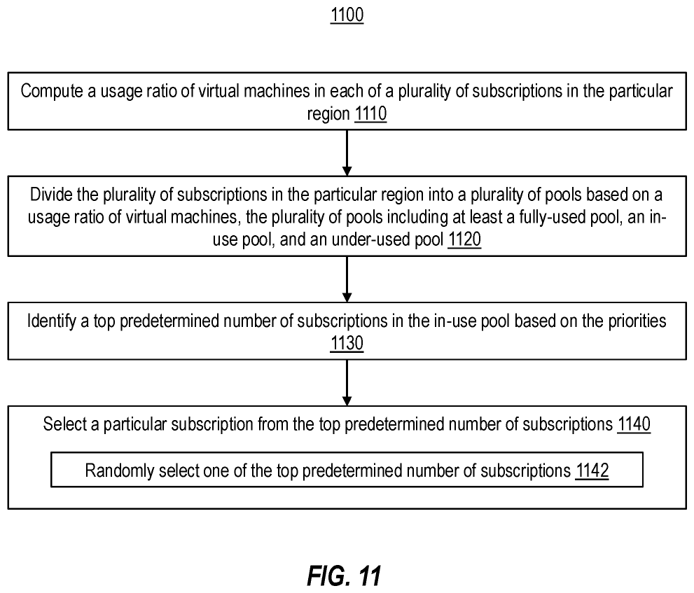

FIG. 11 illustrates a flowchart of an example method 1100 for selecting a particular subscription based on priorities and usage ratio of VMs in each subscription (which may correspond to act 754 of FIG. 7). The method 1100 includes computing a usage ratio of virtual machines in each of the plurality of subscriptions in the particular region (act 1110). The method 1100 further includes dividing the plurality of subscriptions in the particular region into a plurality of pools (act 1120). In some embodiments, the plurality of pools includes at least a fully-used pool, an in-use pool, and an under-used pool. In some embodiments, the subscriptions that have a usage ratio less than a first threshold are placed in the under-used pool, the subscriptions that have a usage ratio greater than a second threshold (greater than the first threshold) are placed in the fully-used pool, and the subscriptions that have a usage ratio between the first threshold and the second threshold are placed in the in-use pool.

The method 1100 further includes identifying a top predetermined number of subscriptions in the in-use pool based on their priorities (act 1130) (which may be determined based on one or more sets of rules described above). In some embodiments, the method 1100 further includes selecting a particular subscription from the top predetermined number of subscriptions (act 1140). In some embodiments, selecting a particular subscription includes randomly selecting one of the top predetermined number of subscriptions (act 1142) to avoid a race situation.

Following are some further example embodiments of the invention. These are presented only by way of example and are not intended to limit the scope of the invention in any way. Further, any example embodiment can be combined with one or more of the example embodiments.

Embodiment one. A computer system that includes one or more processors and one or more computer-readable hardware storage devices having stored on computer-executable instructions that are structured such that, when the computer-executable instructions are executed by the one or more processors, the computer system is configured to perform a plurality of acts. In particular, the computer system is configured to receive a request for allocation of a resource within a cloud environment that comprises a plurality of regions. The computer system is also configured to identify a plurality of subscriptions in each of the plurality of regions. Each subscription is associated with a quota indicating a total amount of resource in the corresponding subscription and a usage amount indicating an amount of used resource in the corresponding subscription. For each region in the plurality of regions, the computer system is further configured to compute a total quota indicating a sum of quotas of the plurality of subscriptions and a total usage amount indicating a sum of used amounts of the plurality of subscriptions in the corresponding region, and compute a total usage ratio indicating a ratio between the total usage amount and the total quota. The computer system is then configured to select a particular region in the plurality of regions for allocation of the resource based on total usage ratios of the plurality of regions, and select a particular subscription in the plurality of subscriptions in the particular region for balancing usage of resources. Selecting the particular subscription includes applying one or more sets of rules to determine a priority for each of the plurality of subscriptions in the particular region based on the one or more sets of rules. Each of the one or more sets of rules is configured to balance usage of a particular type of resource. the particular subscription is then selected based on priorities of the plurality of subscriptions in the particular region. The computer system then allocates the resource that is requested for allocation from the particular subscription based on the request.

Embodiment two. The computer system of embodiment one, wherein the resource that is requested for allocation includes one or more of (1) a virtual machine, (2) a virtual processor, (3) a virtual network, and/or (4) a disk encryption set comprising a customer-managed key, and/or (5) a set of disks.

Embodiment three. The computer system of embodiments one or two, wherein selecting the particular region in the plurality of regions includes for each region in the plurality of regions, determining one or more of (1) a first usage ratio of virtual machines based on a total number of available virtual machines and a first total quota of virtual machines in the corresponding region, (2) a second usage ratio of virtual processors based on a second total number of available virtual processors and a second total quota of virtual processors in the corresponding region, (3) a third usage ratio of virtual networks based on a third total number of available virtual networks and a third total quota of virtual networks in the corresponding region, (4) a fourth usage ratio of customer-managed keys based on a fourth total number of available customer-managed keys and a fourth total quota of customer-managed keys, or (5) a fifth usage ratio of disks based on a fifth total number of available disks and a fifth total quota of disks in the corresponding region. Next, a highest usage ratio among the one or more of the first usage ratio, the second usage ratio, the third usage ratio, the fourth usage ratio, and/or the fifth usage ratio is identified. A lowest ratio among the highest usage ratios in the plurality of subscriptions is then identified, and the particular region that corresponds to the lowest ratio is selected.

Embodiment four. The computer system of embodiment three, wherein the determination of the one or more of the first usage ratio, the second usage ratio, the third usage ratio, or the fourth usage ratio is performed periodically at a predetermined frequency.

Embodiment five. The computer system of embodiments two through four, wherein the one or more sets of rules include at least one of (1) a first set of rules for balancing available virtual processors and available virtual machines, (2) a second set of rules for balancing available virtual networks and available virtual machines, (3) a third set of rules for balancing available customer-managed keys and available virtual machines, or (4) a fourth set of rules for balancking available disks and available virtual machines.

Embodiment six. The computer system of embodiment five, wherein applying the one or more sets of rules includes determining that a particular set of rules in the one or more sets of rules has a higher priority based on a total amount of each type of resource and a total quota of each type of resource in the particular region.

Embodiment seven. The computer system of embodiment six, wherein determining that the particular set of rules has a higher priority includes identifying one or more of (1) a first usage ratio of virtual networks based on a first total amount of available virtual processors and a first total quota of virtual processors in the particular region, (2) a second usage ratio of virtual processors based on a second total amount of available virtual network and a second total quota of the virtual networks in the particular region, or (3) a third usage ratio of disk encryption sets based on a third total amount of available disk encryption sets and a third total quota of disk encryption sets in the particular region. A highest usage ratio among the one or more of the first usage ratio, the second usage ratio, or the third usage ratio is then identified. The set of rules corresponding to a type of resource that has the highest usage ratio is set to have the higher priority.

Embodiment eight. The computer system of embodiments six and seven, wherein the resource that is requested to be allocated includes a number of virtual machines and a number of virtual processors for each virtual machine. The first set of rules are based on the number of virtual processors for each virtual machine and a ratio between available virtual processors and available virtual machines in each subscription in the plurality of subscriptions in the particular region.

Embodiment nine. The computer system of embodiment eight, wherein applying the first set of rules includes computing a ratio between a first number of available virtual processors and a second number of available virtual machines in each subscription in the plurality of subscription in the particular region, and identifying a number of virtual processors for each virtual machine that is requested to be allocated based on the request. For each subscription in the plurality of subscriptions in the particular region, an absolute value of the ratio between the first number and the second number minus the number of virtual processors is computed. The absolute values corresponding to the plurality of subscriptions in the particular region are then ordered (e.g., in ascending order). This order corresponds to the priorities of the plurality of subscriptions in the particular region.

Embodiment ten. The computer system of embodiments six through nine, wherein the resource that is requested to be allocated includes a number of virtual machines and a number of virtual networks. The second set of rules are based on a ratio between the number of virtual machines and the number of virtual network in each of the plurality of subscriptions in the particular region.

Embodiment eleven. The computer system of embodiments six through ten, wherein the resource that is requested to be allocated includes a number of virtual machines and a number of disk encryption sets. The third set of rules are based on a ratio between the number of virtual machines and the number of disk encryption sets in each of the plurality of subscriptions in the particular region.

Embodiment twelve. The computer system of embodiments six through eleven, wherein the requested resource includes a number of virtual machines and a number of disks, and the fourth set of rules are based on a ratio between the number of virtual machines and the number of disks in each subscription in the particular region.

Embodiment thirteen. The computer system of embodiments one through twelve, wherein selecting the particular subscription in the particular region further includes dividing the plurality of subscriptions in the particular region into a plurality of groups based on a usage ratio of virtual machines in each of the plurality of subscriptions in the particular region. The plurality of groups including at least (1) an under-used pool indicating subscriptions that have a usage ratio that is lower than a first threshold, (2) a fully-used pool including subscriptions that have a usage ratio that is greater than a second threshold, and (3) an in-use pool including subscriptions that have a usage ratio between the first threshold and the second threshold, where the first threshold<the second threshold. A top predetermined number of subscriptions in the in-use pool is then identified based on the priorities, and the particular subscription is selected from the top predetermined number of subscriptions.

Embodiment fourteen. The computer system of embodiment thirteen, wherein each usage ratio of virtual machines is computed based on assuming a number of virtual machines that are requested to be allocated have been allocated into each of the plurality of subscriptions.

Embodiment fifteen. The computer system of embodiments thirteen and fourteen, wherein the particular subscription is randomly selected from the top predetermined number of subscriptions.

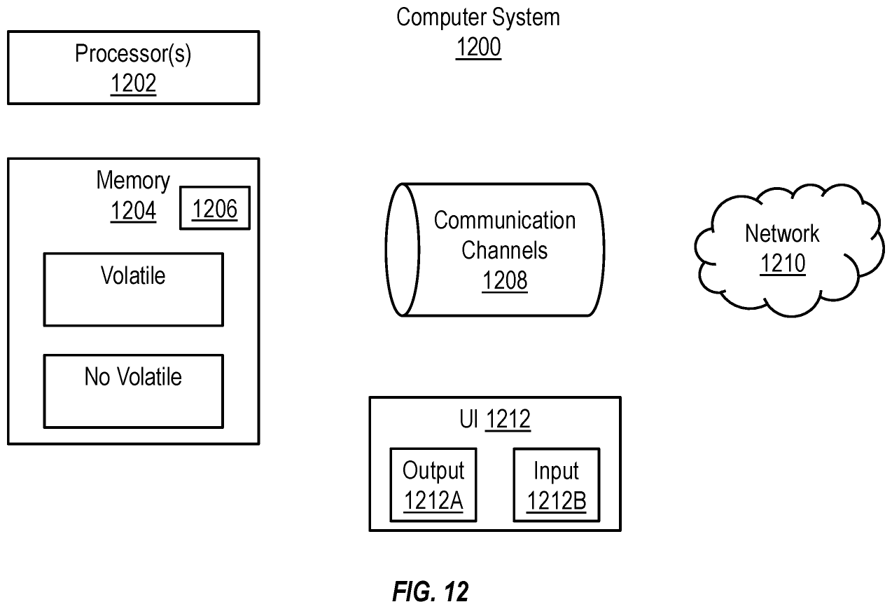

Finally, because the principles described herein may be performed in the context of a computer system (for example, the client computer system 110, the cloud service computer system 120, the provision manager 122, the capacity manager 130, and/or each subscription 152, 154, 156, 162, 164, 166, 172, 174, 176 are all implemented at a computer system) some introductory discussion of a computer system will be described with respect to FIG. 12.

Computer systems are now increasingly taking a wide variety of forms. Computer systems may, for example, be hand-held devices, appliances, laptop computers, desktop computers, mainframes, distributed computer systems, data centers, or even devices that have not conventionally been considered a computer system, such as wearables (e.g., glasses). In this description and in the claims, the term “computer system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computer system. A computer system may be distributed over a network environment and may include multiple constituent computer systems.

As illustrated in FIG. 12, in its most basic configuration, a computer system 1200 typically includes at least one hardware processing unit 1202 and memory 1204. The processing unit 1202 may include a general-purpose processor and may also include a field-programmable gate array (FPGA), an application-specific integrated circuit (ASIC), or any other specialized circuit. The memory 1204 may be physical system memory, which may be volatile, non-volatile, or some combination of the two. The term “memory” may also be used herein to refer to non-volatile mass storage such as physical storage media. If the computer system is distributed, the processing, memory and/or storage capability may be distributed as well.

The computer system 1200 also has thereon multiple structures often referred to as an “executable component”. For instance, memory 1204 of the computer system 1200 is illustrated as including executable component 1206. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computer system, whether such an executable component exists in the heap of a computer system, or whether the executable component exists on computer-readable storage media.

In such a case, one of ordinary skill in the art will recognize that the structure of the executable component exists on a computer-readable medium such that, when interpreted by one or more processors of a computer system (e.g., by a processor thread), the computer system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computer systems. If such acts are implemented in software, one or more processors (of the associated computer system that performs the act) direct the operation of the computer system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 1204 of the computer system 1200. Computer system 1200 may also contain communication channels 1208 that allow the computer system 1200 to communicate with other computer systems over, for example, network 1210.

While not all computer systems require a user interface, in some embodiments, the computer system 1200 includes a user interface system 1212 for use in interfacing with a user. The user interface system 1212 may include output mechanisms 1212A as well as input mechanisms 1212B. The principles described herein are not limited to the precise output mechanisms 1212A or input mechanisms 1212B as such will depend on the nature of the device. However, output mechanisms 1212A might include, for instance, speakers, displays, tactile output, holograms, and so forth. Examples of input mechanisms 1212B might include, for instance, microphones, touchscreens, holograms, cameras, keyboards, mouse or other pointer input, sensors of any type, and so forth.

Embodiments described herein may comprise or utilize a special purpose or general-purpose computer system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computer system.

A “network” is defined as one or more data links that enable the transport of electronic data between computer systems and/or modules and/or other electronic devices. When information is transferred or provided over a network or another communications connection (either hard-wired, wireless, or a combination of hard-wired or wireless) to a computer system, the computer system properly views the connection as a transmission medium. Transmissions media can include a network and/or data links that can be used to carry desired program code means in the form of computer-executable instructions or data structures and which can be accessed by a general-purpose or special-purpose computer system. Combinations of the above should also be included within the scope of computer-readable media.

Further, upon reaching various computer system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computer system RAM and/or to less volatile storage media at a computer system. Thus, it should be understood that storage media can be included in computer system components that also (or even primarily) utilize transmission media.

Computer-executable instructions comprise, for example, instructions and data which, when executed at a processor, cause a general-purpose computer system, special purpose computer system, or special purpose processing device to perform a certain function or group of functions. Alternatively or in addition, the computer-executable instructions may configure the computer system to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computer systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computer systems which may correspond to the computer system 1200 previously described. The computer systems of the remaining figures include various components or functional blocks that may implement the various embodiments disclosed herein, as will be explained. The various components or functional blocks may be implemented on a local computer system or may be implemented on a distributed computer system that includes elements resident in the cloud or that implement aspect of cloud computing. The various components or functional blocks may be implemented as software, hardware, or a combination of software and hardware. The computer systems of the remaining figures may include more or less than the components illustrated in the figures, and some of the components may be combined as circumstances warrant. Although not necessarily illustrated, the various components of the computer systems may access and/or utilize a processor and memory, such as processing unit 1202 and memory 1204, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
one or more processors; and
one or more computer-readable hardware storage devices having stored thereon computer-executable instructions that are structured such that, when the computer-executable instructions are executed by the one or more processors, the computer system is configured to:
receive a request for allocation of a resource within a cloud environment that comprises a plurality of regions;
identify a plurality of subscriptions in each of the plurality of regions, each subscription associated with a quota indicating a total amount of resource in a corresponding subscription and a usage amount indicating an amount of used resource in the corresponding subscription;
for each region in the plurality of regions,
compute a total quota indicating a sum of quotas of the plurality of subscriptions and a total usage amount indicating a sum of used amounts of the plurality of subscriptions in the corresponding region; and
compute a total usage ratio indicating a ratio between the total usage amount and the total quota;
select a particular region in the plurality of regions into which to allocate the resource based on total usage ratios of the plurality of regions;
select a particular subscription in the plurality of subscriptions in the particular region based on usage of resources in the plurality of subscriptions, comprising:
determining a priority for each of the plurality of subscriptions in the particular region based on at least one rule, the at least one rule configured to balance usage of at least a particular type of resource; and
selecting the particular subscription in the plurality of subscriptions in the particular region based on priorities of the plurality of subscriptions in the particular region; and
allocate the resource that is requested for allocation from the particular subscription based on the request.

2. The computer system of claim 1, wherein the resource that is requested for allocation includes at least one of (1) a virtual machine, (2) a virtual processor, (3) a virtual network, (4) a disk encryption set comprising a customer-managed key, or (5) a set of disks.

3. The computer system of claim 2, wherein selecting the particular region in the plurality of regions includes:
for each region in the plurality of regions,
determining at least one of (1) a first usage ratio of virtual machines based on a total number of available virtual machines and a first total quota of virtual machines in the corresponding region, (2) a second usage ratio of virtual processors based on a second total number of available virtual processors and a second total quota of virtual processors in the corresponding region, (3) a third usage ratio of virtual networks based on a third total number of available virtual networks and a third total quota of virtual networks in the corresponding region, (4) a fourth usage ratio of customer-managed keys based on a fourth total number of available customer-managed keys and a fourth total quota of customer-managed keys in the corresponding region, or (5) a fifth usage ratio of disks based on a fifth total number of available disks and a fifth total number of available disks and a fifth total quota of disks; and
identifying a highest usage ratio among the at least one of the first usage ratio, the second usage ratio, the third usage ratio, or the fourth usage ratio;
identify a lowest ratio among the highest usage ratios of the plurality of regions; and
select the particular region that corresponds to the lowest ratio.

4. The computer system of claim 3, wherein determining the at least one of the first usage ratio, the second usage ratio, the third usage ratio, or the fourth usage ratio is performed periodically at a predetermined frequency.

5. The computer system of claim 2, wherein the at least one rule include at least one of (1) a first set of rules for balancing available virtual processors and available virtual machines, (2) a second set of rules for balancing available virtual networks and available virtual machines, (3) a third set of rules for balancing available customer-managed keys and available virtual machines, or (4) a fourth set of rules for balancing available disks and available virtual machines.

6. The computer system of claim 5, wherein the computer system is further configured to determine that a particular set of rules in the at least one rule has a higher priority based on a total available amount of each type of resource and a total quota of each type of resource in the particular region.

7. The computer system of claim 6, determining that the particular set of rules has a higher priority comprising:
Identifying at least one of (1) a first usage ratio of virtual processors based on a first total amount of available virtual processors and a first total quota of virtual processors in the particular region, (2) a second usage ratio of virtual networks based on a second total amount of available virtual networks and a second total quota of the virtual networks in the particular region, (3) a third usage ratio of customer-managed keys in disk encryption sets based on a third total amount of available customer-managed keys and a third total quota of customer-managed keys in the particular region, or (4) a fourth usage ratio of disks in disk encryption sets based on a fourth total amount of available disks and a fourth total quota of disks in the particular region;
identifying a highest usage ratio among the at least one of the first usage ratio, the second usage ratio, the third usage ratio, or the fourth usage ratio; and
determining the set of rules corresponding to a type of resource that has the highest usage ratio to have the higher priority.

8. The computer system of claim 6, wherein:
the computer system is a first computer system configured to provide a cloud service that allocates resource to a plurality of customers;
the request for resource is initiated by a second computer system associated with one of the plurality of customers of the cloud service;
the resource that is requested to be allocated includes a number of virtual machines and a number of virtual processors for each virtual machine; and
the first set of rules are based on the number of virtual processors for each virtual machine and a ratio between available virtual processors and available virtual machines in each subscription in the plurality of subscriptions in the particular region.

9. The computer system of claim 8, wherein applying the first set of rules includes:
computing a ratio between a first number of available virtual processors and a second number of available virtual machines in each subscription in the plurality of subscriptions in the particular region;
identifying a number of virtual processors for each virtual machine that is requested to be allocated based on the request;
for each subscription in the plurality of subscriptions in the particular region, computing an absolute value of the ratio between the first number and the second number minus the number of virtual processors; and
ordering the absolute values corresponding to the plurality of subscriptions in the particular region in an order corresponding to the priorities of the plurality of subscriptions in the particular region.

10. The computer system of claim 6, wherein:
the resource that is requested to be allocated includes a number of virtual machines and a number of virtual networks; and
the second set of rules are based on a ratio between the number of virtual machines and the number of virtual network in each of the plurality of subscriptions in the particular region.

11. The computer system of claim 6, wherein:
the resource that is requested to be allocated includes a number of virtual machines and a number of customer-managed keys; and
the third set of rules are based on a ratio between the number of virtual machines and the number of customer-managed keys in each of the plurality of subscriptions in the particular region.

12. The computer system of claim 6, wherein:
the requested resource includes a number of virtual machines and a number of disks; and
the fourth set of rules are based on a ratio between the number of virtual machines and the number of disks in each subscription in the particular region.

13. The computer system of claim 1, wherein:
selecting the particular subscription in the particular region further includes:
computing a usage ratio of virtual machines in each of the plurality of subscriptions in the particular region;
dividing the plurality of subscriptions in the particular region into a plurality of groups based on a usage ratio of virtual machines in each of the plurality of subscriptions in the particular region, the plurality of groups including at least (1) an under-used pool including subscriptions that have a usage ratio that is lower than a first threshold, (2) a fully-used pool including subscriptions that have a usage ratio that is greater than a second threshold lower than the first threshold, and (3) an in-use pool including subscriptions that have a usage ratio between the first threshold and the second threshold, where the first threshold<the second threshold;
identifying a top predetermined number of subscriptions in the in-use pool based on the priorities; and
selecting the particular subscription from the top predetermined number of subscriptions.

14. The computer system of claim 13, wherein each usage ratio of virtual machines is computed based on assuming a number of virtual machines that are requested to be allocated have been allocated into each of the plurality of subscriptions.

15. The computer system of claim 13, wherein the particular subscription is randomly selected from the top predetermined number of subscriptions.

16. A method implemented at a computer system for intelligent allocation of resources in a cloud environment, the method comprising:
receiving a request for allocation of a resource within the cloud environment that comprises a plurality of regions;
identifying a plurality of subscriptions in each of the plurality of regions, each subscription associated with a quota indicating a total amount of resource in a corresponding subscription and a usage amount indicating an amount of used resource in the corresponding subscription;
for each region in the plurality of regions,
computing a total quota indicating a sum of quotas of the plurality of subscriptions and a total usage amount indicating a sum of used amounts of the plurality of subscriptions in the corresponding region; and
computing a total usage ratio indicating a ratio between the total usage amount and the total quota;
selecting a particular region in the plurality of regions into which to allocate the resource based on total usage ratios of the plurality of regions;
selecting a particular subscription in the plurality of subscriptions in the particular region based on usage of resource in the plurality of subscriptions, comprising:
determining a priority for each of the plurality of subscriptions in the particular region based on at least one rule, the at least one rule configured to balance usage of at least a particular type of resource; and
selecting the particular subscription in the plurality of subscriptions in the particular region based on priorities of the plurality of subscriptions in the particular region; and
allocating the resource that is requested for allocation from the particular subscription based on the request.

17. The method of claim 16, wherein the resource that is requested for allocation includes at least one of (1) a virtual machine, (2) a virtual processor, (3) a virtual network, or (4) a disk encryption set comprising a customer-managed key.

18. The method of claim 17, wherein selecting the particular region in the plurality of regions includes:
for each region in the plurality of regions,
determining at least one of (1) a first usage ratio of virtual machines based on a total number of available virtual machines and a first total quota of virtual machines in the corresponding region, (2) a second usage ratio of virtual processors based on a second total number of available virtual processors and a second total quota of virtual processors in the corresponding region, (3) a third usage ratio of virtual networks based on a third total number of available virtual networks and a third total quota of virtual networks in the corresponding region, (4) a fourth usage ratio of customer-managed keys based on a fourth total number of available customer-managed keys and a fourth total quota of customer-managed keys in the corresponding region, or (5) a fifth usage ratio of disks based on a fifth total number of available disks and a fifth total number of available disks and a fifth total quota of disks; and
identifying a highest usage ratio among the at least one of the first usage ratio, the second usage ratio, the third usage ratio, or the fourth usage ratio;
identifying a lowest ratio among the highest usage ratios of the plurality of regions; and
selecting the particular region that corresponds to the lowest ratio.

19. The method of claim 18, wherein determining the at least one of the first usage ratio, the second usage ratio, the third usage ratio, or the fourth usage ratio is performed periodically at a predetermined frequency.

20. A computer program product comprising at least one hardware storage device having stored thereon computer-executable instructions that are structured such that, when the computer-executable instructions are executed by at least one processor of a computer system, the computer-executable instructions configure the computer system to perform:
receive a request for allocation of a resource within a cloud environment that comprises a plurality of regions;
identify a plurality of subscriptions in each of the plurality of regions, each subscription associated with a quota indicating a total amount of resource in a corresponding subscription and a usage amount indicating an amount of used resource in the corresponding subscription;
for each region in the plurality of regions,
compute a total quota indicating a sum of quotas of the plurality of subscriptions and a total usage amount indicating a sum of used amounts of the plurality of subscriptions in the corresponding region; and
compute a total usage ratio indicating a ratio between the total usage amount and the total quota;
select a particular region in the plurality of regions into which to allocate the resource based on total usage ratios of the plurality of regions;
select a particular subscription in the plurality of subscriptions in the particular region based on usage of resource in the plurality of subscriptions, comprising:
determining a priority for each of the plurality of subscriptions in the particular region based on at least one rule, the at least one rule configured to balance usage of at least a particular type of resource; and
selecting the particular subscription in the plurality of subscriptions in the particular region based on priorities of the plurality of subscriptions in the particular region; and
allocate the resource that is requested for allocation from the particular subscription based on the request.
